(19) United States
(12) Patent Application Publication
(10) Pub. No.: US 2007/0012729 A1
(43) Pub. Date: Jan. 18, 2007

(54) Glue gun apparatus with remote operating mechanism

(76) Inventor: Laura Ort, Kendallville, IN (US)

Correspondence Address: TAYLOR & AUST, P.C., 142 SOUTH MAIN STREET, P. O. BOX 560, AVILLA, IN, 46710, US

(21) Appl. No.: 11/485,543

(22) Filed: Jul. 12, 2006

Related U.S. Application Data
(60) Provisional application No. 60/700,366, filed on Jul. 18, 2005.

(51) Int. Cl. B67D 5/06

(52) U.S. Cl. 222/179

(57) ABSTRACT

An apparatus including a glue gun, a support structure on which the glue gun is mounted, and a user-controlled operating mechanism. The operating mechanism is coupled to the glue gun and spaced apart from the support structure. The operating mechanism may be a foot-operated pedal that is coupled to the glue gun with a Bowden cable. Depressing the pedal actuates the glue gun thereby dispensing glue from the gun. The foot-operated pedal allows a user to use two hands to manipulate a work piece onto which glue is being dispensed. The Bowden cable may be coupled to an actuator that engages a trigger on the glue gun. The actuator may be slidingly mounted on the support structure or it may be supported by the trigger.

### CROSS REFERENCE TO RELATED APPLICATIONS

This is a non-provisional application based upon U.S. provisional patent application Ser. No. 60/700,366, entitled “GLUE GUN WITH REMOTE OPERATING MECHANISM”, filed Jul. 18, 2005.

### BACKGROUND OF THE INVENTION

1. Field of the Invention

The present invention relates to glue guns and, more specifically, to an actuating mechanism for a glue gun that is located remotely from the glue gun.

2. Description of the Related Art

Glue guns are a common tool that are used in both residential and professional situations. Glue guns typically receive a cylindrical prepackaged cartridge of glue which the gun heats and dispenses. Glue guns are available in a variety of configurations, however, glue guns often have a shape that is generally similar to that of a pistol. Such pistol shaped glue guns typically have a trigger which is depressed to dispense glue. In use, the operator will typically hold the glue gun in one hand and either point the nozzle of the gun at the location where it is desired to apply the glue. If glue is to be applied to a workpiece that must be held in place, the workpiece must either be clamped or held with the free hand of the operator.

While this mode of operating a glue gun will suffice for most applications, it can prove problematic for other applications. For example, oftentimes a glue gun will be used to secure two or more workpieces together and it may not be easy or possible to hold all the workpieces in a single hand. The use of a clamp to hold the workpieces will not be desirable and may not be feasible where the workpieces would be damaged by the clamp or have a shape that is difficult to secure within a clamp. Additionally, for some applications the placement of the glue on the workpiece requires a precision that is best achieved by moving the workpiece relative to a stationary glue gun. An apparatus which addresses some or all of these concerns is desirable.

### SUMMARY OF THE INVENTION

The present invention provides an apparatus for holding a glue gun and which includes a remote actuating mechanism that can be activated by the foot of the operator.

The invention comprises, in one form thereof, an apparatus for actuating a glue gun that includes a user-controlled operating mechanism operably coupled to the glue gun wherein said operating mechanism selectively actuates the glue gun, and a support structure adapted to support the glue gun. The support structure spaced apart from said operating mechanism.

Operating mechanism may be foot-operable pedal and be coupled to the glue gun with a cable disposed within an outer sleeve. The cable may be coupled to the glue gun by an actuator engaged with the glue gun. The actuator may be slidably mounted on the support structure and engage a trigger on the glue gun. Alternatively the cable may extend through a pistol grip and a trigger on the glue gun with an actuator engaged with the trigger being secured to the distal end of the cable.

The invention comprises, in another form thereof, a method of operating a glue gun. The method includes mounting the glue gun on a support structure and operably coupling an operating mechanism to the glue gun wherein activation of the operating mechanism dispenses glue from the glue gun. The method further includes activating the operating mechanism with the foot of a user and thereby dispensing glue from the glue gun.

An advantage of the present invention is that enables a user to selectively dispense glue from a glue gun with a foot thereby freeing both hands of the user to manipulate one or more workpieces to which the glue is being applied.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a front view of a first embodiment of the present invention.

FIG. 2 is a side view of the first embodiment.

FIG. 3 is a plan view of a portion of the support structure for the glue gun.

FIG. 4 is a side view of an actuator.

FIG. 5 is a front view of a second embodiment of the present invention.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

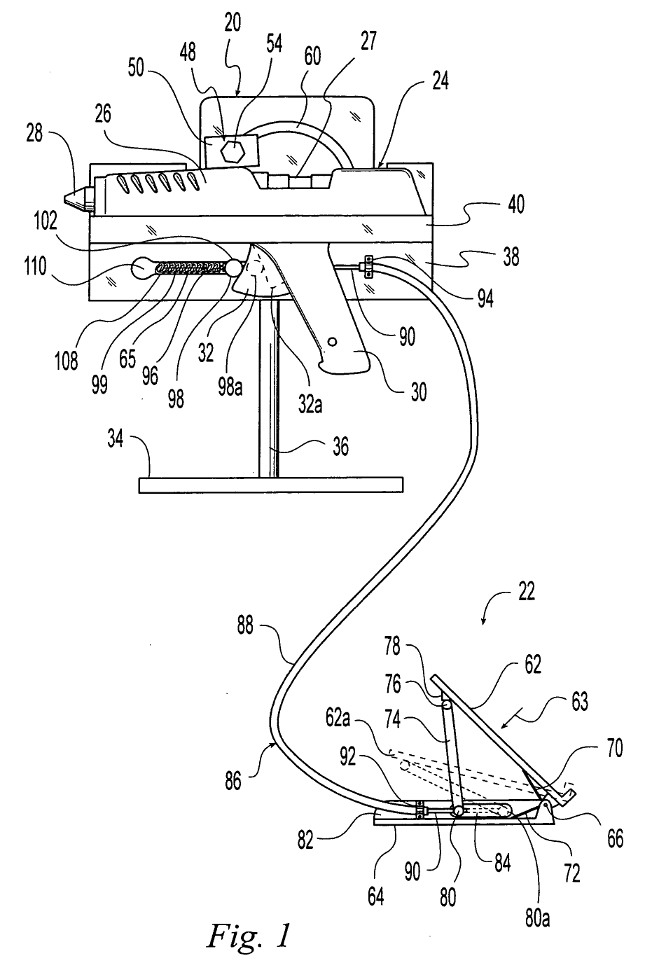

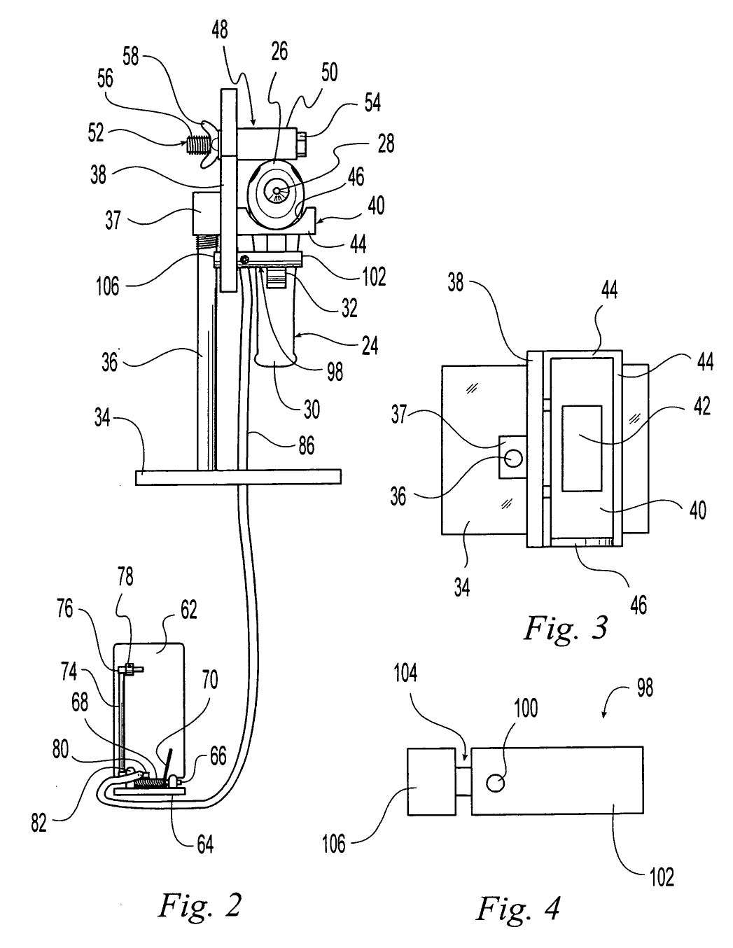

Referring now to the drawings, and more particularly to FIGS. 1 and 2, there is shown a supporting structure 20 and a remote operating mechanism 22 for use with glue gun 24. Glue gun 24 is a conventional glue gun which receives a glue cartridge 27 and includes a power cord (not shown) for electrically connecting glue gun with a conventional electrical outlet for heating the glue within cartridge 27. Glue gun 24 has a barrel 26 in which the glue cartridge is located with a dispensing nozzle 28 at one end. Glue gun 24 also has a pistol grip 30 and a trigger 32. Depressing trigger 32 towards the pistol grip dispenses glue from nozzle 28.

Support structure 20 includes a base 34 which rests upon a horizontal surface such as the top of a work bench. Alternatively, base 34 can be configured with a clamping arrangement for clamping support structure 20 to a work surface. A riser 36 extends upwardly from base 34. Riser 36 is a cylindrical rod having a lower threaded end that is engaged with a threaded bore in base plate 34 and an upper threaded end engaged with threaded mounting block 37. Mounting block 37 is affixed to the backside of support plate 38 as best seen in FIG. 3. Support plate 38 also has a gun tray 40 extending outwardly therefrom. Mounting block 37 and tray 40 are secured to support plate 38 by welding or other suitable means. Tray 40 has an opening 42 through which pistol grip 30 is inserted when mounting glue gun 24 on support structure 20. Tray 40 also includes sidewalls 44 along its edges which can limit the horizontal movement of glue gun 24 on support structure 20. One of the sidewalls 44 includes an upper surface 46 which forms a U-shaped recession to receive the barrel of glue gun 24 and allow the nozzle 28 to project outwardly from tray 40.

Support structure 20 also includes a clamping mechanism 48. Clamping mechanism 48 includes clamping block 50 and bolt 52. Bolt 52 is inserted through a bore in block 50 and arcuate slot 60 in support plate 38 until bolt head 54 engages block 50. Block 50 is secured in place to hold glue gun 24 by tightening wing nut 58 on threaded shaft 56 of bolt 52. Block 50 is positioned to engage the top surface of barrel 26 and thereby firmly secure glue gun 24 in tray 40. Providing an arcuate groove 60 allows block 50 to be secured in a variety of different positions and thereby accommodate different glue gun shapes and sizes and/or change the angular orientation of glue gun 24 relative to base 34. It is also possible to secure glue gun 24 within tray 40 using other suitable fastening techniques, such as Velcro straps, etc. while at the same time allowing angular adjustment of glue gun 24.

Operating mechanism 22 is used to selectively dispense glue from glue gun 24. Operating mechanism includes a pedal 62 and base plate 64. Base plate 64 may be set upon a horizontal surface, e.g., on the floor below the work surface on which support mechanism 20 is positioned. Pedal 62 is pivotally mounted to base plate 64 near the lower end of pedal 62 with pivot pin 66. A biasing element 68 biases pedal 62 toward its first upright position depicted in FIGS. 1 and 2. In the illustrated embodiment, biasing element 68 is a torsional spring mounted on pivot pin 66. Torsional spring 68 has first and second ends 70, 72 engaged with pedal 62 and base plate 64 respectively to bias pedal 62 towards its upright position.

A connecting rod 74 has a pivot pin 76 extending laterally from its upper end and extending through a projection 78 located on the upper backside of pedal 62 to pivotally connect rod 74 to pedal 62. The lower end of connecting rod 74 has a laterally extending projection 80 which extends through a horizontally extending slot 84 in rib 82 which projects upwardly from base plate 64. When pedal 62 is depressed by the foot of a user as indicated by arrow 63 it will move to a second depressed position as indicated by dashed lines 62a in FIG. 1. As pedal 62 moves to this second position 62a, the upper end of connecting rod 74 will pivot about pin 76 and the lower end of connecting rod 74 will move horizontally causing projection 80 to slide within slot 84 to the position indicated by dashed circle 80a.

A Bowden cable 86 is used to couple operating mechanism 22 with glue gun 24 so that when pedal 62 is moved to position 62a, glue will be dispensed from glue gun 24. Bowden cable 86 includes an outer sleeve 88 and an inner cable 90 that can slide relative to outer sleeve 88. A first end of the outer sleeve is clamped to rib 82 with clamp 92. Cable 90 extends outward from sleeve 88 near clamp 92 and is secured to pin 80. Thus, as pin 80 is moved to position 80a by the depression of pedal 62, pin 80 pulls cable 90 relative to sleeve 88.

The other end of sleeve 88 is clamped to support plate 38 by clamp 94. Cable 90 has a distal end 96 that extends outwardly from sleeve 88 at clamp 94 and which is secured to actuator 98. Actuator 98 is best seen in FIG. 4 and has a generally cylindrical shape. Actuator 98 includes an aperture 100 in which distal end 96 of cable 90 is secured. Actuator 98 includes a projecting end 102 that extends outwardly from support plate 38 to engage trigger 32 and a slot 104 between projecting end 102 and retaining end 106. Support plate 38 includes a slot 108 in which actuator 98 is slidably mounted. Acuator 98 is mounted in slot 98 by inserting retaining end 106 through enlarged opening 110 in support plate 38 and then mating slot 104 on actuator 98 with slot 108 in plate 38.

A biasing element 65 configured as a tension spring biases trigger 32 to the non-depressed state shown in FIG. 1. Spring 65 is connected at one end with actuator 98 and coupled at an opposite end with support plate 38. Spring 65 may be positioned within slot 108 as shown in FIGS. 1 and 2, or coupled between support plate 38 and an outboard end of actuator 98 adjacent retaining end 106. Alternatively, spring 65 could be configured as a compression, leaf or other type of spring as long as trigger 32 is biased to a non-depressed state.

When cable 90 is pulled by pin 80 to position 80a, the distal end 96 of cable 90 slides actuator 98 towards pistol grip 30 within slot 108 in the direction indicated by arrow 99, to the position indicated by dashed circle 98a. When actuator 98 has been moved to the position 98a by the depression of pedal 62 and consequent movement of cable 90, trigger 32 will be moved to the position indicated by dashed outline 32a thereby causing glue to be dispensed from nozzle 28.

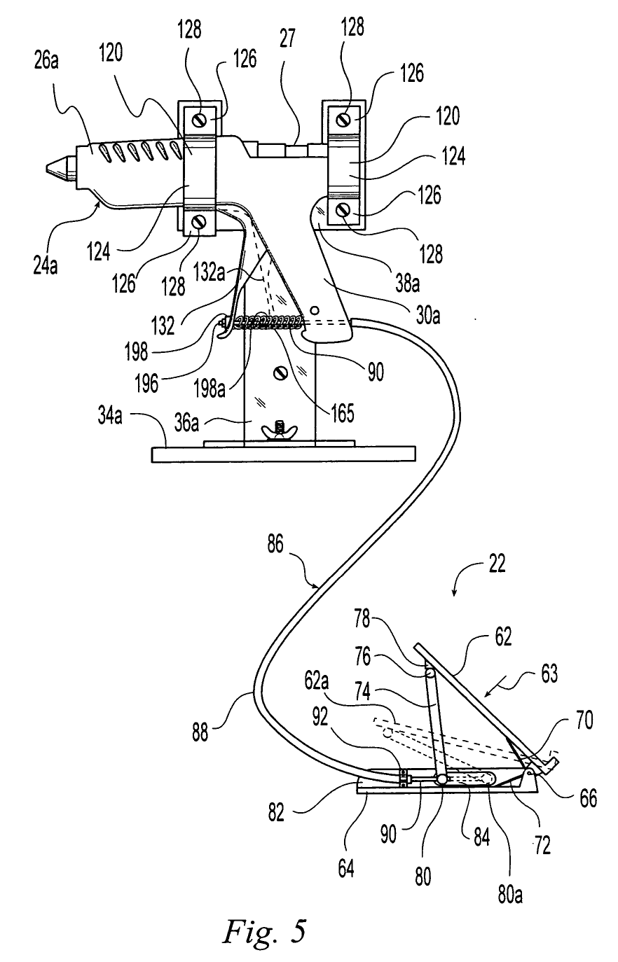

Referring now to FIG. 5, there is shown a second embodiment of a support structure 20a and glue gun 24a. The operating mechanism 22 used with this second embodiment has a similar construction and operation as that discussed above and a discussion of the operating mechanism 22 of the second embodiment will not be repeated. Similar to the support structure 20 illustrated in FIGS. 1-3, support structure 20a includes a base 34a and a riser 36a. A support plate 38 is attached to riser 36a. Glue gun 24a is firmly secured to support structure 20a by the clamping mechanism defined by brackets 120. Each of the brackets 120 have a semicircular central region 124 in which the barrel 26a of glue gun 24a is seated. Mounting tabs 126 are located on each end of central region 124. Threaded fasteners 128 extend through mounting tabs 126 to secure brackets 120 to plate 38 and thereby secure glue gun 24a on support structure 20a. To couple glue gun 24a with operating mechanism 22, holes are drilled through pistol grip 30a and trigger 132 of glue gun 24a. The distal end 196 of cable 90 is then threaded through the holes in pistol grip 30a and trigger 132. An actuator 198 is then secured to distal end 196 and bears against trigger 132. When pedal 62 is depressed, pin 80 will be moved to position 80a pulling cable 90 through outer sleeve 88. One end of sleeve 88 bears against pistol grip 30a and thereby pulls distal end 196 of cable 90 towards pistol grip 30a when cable 90 is pulled through sleeve 88 by the depression of pedal 62. As distal end 196 is pulled toward pistol grip 30a, actuator 198 bears against trigger 132 and thereby pulls trigger 132 toward pistol grip 30a resulting in the dispensing of glue from gun 24a. Dashed lines 198a depict the position of actuator 198 and dashed lines 132a depict the position of trigger 132 when pedal 62 has been depressed to dispense glue from gun 24a. By mounting actuator 198 on the distal end 196 of cable 90 that has been threaded through an opening in trigger 132, actuator 198 is supported by trigger 132. In the illustrated embodiment, actuator 198 is a nut and washer assembly; however, alternative types of actuators may also be employed. A biasing element 165 configured as a compression spring biases trigger 132 to the non-depressed state shown in FIG. 5. Spring 165 is interposed between trigger 132 and pistol grip 30a.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for actuating a glue gun, said apparatus comprising:
a user-controlled operating mechanism operably coupled to the glue gun, said operating mechanism selectively actuating the glue gun; and
a support structure adapted to support the glue gun, said support structure spaced apart from said operating mechanism.

2. The apparatus of claim 1, wherein said operating mechanism is a foot-operable and has a pedal mounted on a base plate, a lower portion of said pedal being pivotally mounted to said base plate.

3. The apparatus of claim 2, further comprising a cable disposed within an outer sleeve, said cable operably coupling said pedal and the glue gun.

4. The apparatus of claim 3, wherein said pedal has a first position and a second position and said operating mechanism further comprises a biasing element biasing said pedal towards said first position, movement of said pedal from said first position to said second position actuating the glue gun.

5. The apparatus of claim 1, further comprising a cable disposed within an outer sleeve, said cable operably coupling said operating mechanism and the glue gun.

6. The apparatus of claim 5, further comprising an actuator engageable with the glue gun, said cable operably coupling actuator and said operating mechanism.

7. The apparatus of claim 6, wherein said actuator is moveably supported on said holder.

8. The apparatus of claim 7, wherein said actuator is slidably disposed in a slot on said support structure and has an end projecting outwardly therefrom, said projecting end being engageable with a trigger of the glue gun.

9. The apparatus of claim 8, wherein said support structure is engageable with the glue gun to limit the movement of the glue gun.

10. The apparatus of claim 9, wherein said support structure includes a clamping mechanism engageable with the glue gun whereby the glue gun is firmly securable on said support structure.

11. The apparatus of claim 6, wherein said actuator is supported on the glue gun.

12. The apparatus of claim 11, wherein said cable includes a distal end, said distal end of said cable being threadable through both a pistol grip and a trigger on the glue gun and said actuator is secured to said distal end and is engageable with the trigger.

13. The apparatus of claim 1, wherein said support structure includes a clamping mechanism engageable with the glue gun whereby the glue gun is firmly securable on said support structure.

14. An apparatus comprising:
a glue gun;
a support structure, said glue gun mounted on said support structure; and
a user-controlled operating mechanism operably coupled to said glue gun and spaced apart from said support structure.

15. The apparatus of claim 14, wherein said operating mechanism is a foot-operable and has a pedal mounted on a base plate, a lower portion of said pedal being pivotally mounted to said base plate.

16. The apparatus of claim 15, further comprising a cable disposed within an outer sleeve, said cable operably coupling said pedal and said glue gun.

17. The apparatus of claim 16, wherein said pedal has a first position and a second position and said operating mechanism further comprises a biasing element biasing said pedal towards said first position, movement of said pedal from said first position to said second position actuating said glue gun.

18. The apparatus of claim 14, further comprising a cable disposed within an outer sleeve, said cable operably coupling said operating mechanism and said glue gun.

19. The apparatus of claim 18, further comprising an actuator engaged with said glue gun, said cable operably coupling actuator and said operating mechanism.

20. The apparatus of claim 19, wherein said actuator is moveably supported on said holder.

21. The apparatus of claim 20, wherein said glue gun has a dispensing trigger and said actuator is slidably disposed in a slot on said support structure and has an end projecting outwardly therefrom, said projecting end being engaged with said trigger.

22. The apparatus of claim 21, wherein said support structure engageably limits movement of said glue gun.

23. The apparatus of claim 22, wherein said support structure includes a clamping mechanism firmly securing said glue gun on said support structure.

24. The apparatus of claim 19, wherein said actuator is supported on said glue gun.

25. The apparatus of claim 24, wherein said glue gun includes a pistol grip and a trigger, each of said pistol grip and said trigger defining an aperture extending therethrough, said cable extending through said apertures in said pistol grip and said trigger and having a distal end extending through said aperture in said trigger, said actuator secured to said distal end and being engageable with said trigger.

26. The apparatus of claim 14, wherein said support structure includes a clamping mechanism firmly securing said glue gun on said support structure.

27. A method of operating a glue gun, said method comprising:
mounting the glue gun on a support structure;
operably coupling an operating mechanism to the glue gun, wherein activation of the operating mechanism dispenses glue from the glue gun; and
activating the operating mechanism with the foot of a user and thereby dispensing glue from the glue gun.

28. The method of claim 27, wherein said step of mounting the glue gun on the support structure includes firmly clamping the glue gun on the support structure.

29. The method of claim 27, wherein said step of operably coupling the operating mechanism to the glue gun includes providing a cable disposed within an outer sleeve and operably coupling the cable to both the operating mechanism and the glue gun.

30. The method of claim 29, wherein the operating mechanism is a pedal pivotally mounted on a base.

31. The method of claim 29, wherein the step of operably coupling the operating mechanism to the glue gun includes providing an actuator, engaging the actuator with the glue gun and operably coupling the actuator to the operating mechanism with the cable.

32. The method of claim 31, further comprising the step of slidingly mounting the actuator on the support structure and engaging the actuator with a trigger on the glue gun.

33. The method of claim 29, wherein operably coupling the cable to the glue gun includes threading the cable through both a pistol grip and a trigger on the glue gun and operably coupling a distal end of the cable with the trigger.
